(19) United States
(12) Patent Application Publication
(10) Pub. No.: US 2020/0061702 A1
(43) Pub. Date: Feb. 27, 2020

(54) THREE-DIMENSIONAL SHAPED ARTICLE PRODUCING COMPOSITION, PRODUCTION METHOD FOR THREE-DIMENSIONAL SHAPED ARTICLE, AND THREE-DIMENSIONAL SHAPED ARTICLE PRODUCTION APPARATUS

(71) Applicant: Seiko Epson Corporation, Tokyo (JP)

(72) Inventors: Masaya ISHIDA, Torrance, CA (US); Takeshi MIYASHITA, Suwa (JP); Eiji OKAMOTO, Matsumoto (JP); Akihiko TSUNOYA, Okaya (JP); Naoko SHIMA, Shiojiri (JP); Makoto KATO, Shiojiri (JP)

(21) Appl. No.: 16/489,290

(22) PCT Filed: Jan. 18, 2018
(86) PCT No.: PCT/JP2018/001400

§ 371 Date: Aug. 27, 2019

(30) Foreign Application Priority Data
Feb. 28, 2017 (JP) 2017-037571

(51) Int. Cl. B22F 1/00; B22F 3/105; B22F 3/16; B28B 1/30

(52) U.S. Cl. CPC B22F 1/0062; B22F 3/105; B33Y 30/00; B28B 1/30; B22F 3/16

(57) ABSTRACT

A three-dimensional shaped article producing composition is provided and contains a plurality of particles, a solvent for dispersing the particles, and nanocellulose.

### BACKGROUND

### Technical Field

The present invention relates to a three-dimensional shaped article producing composition, a production method for a three-dimensional shaped article, and a three-dimensional shaped article production apparatus.

### Related Art

Heretofore, production of a three-dimensional shaped article using a composition containing a plurality of particles has been performed. In particular, recently, a stacking method (three-dimensional shaping method), in which model data of a three-dimensional object is divided into a large number of two-dimensional sectional layer data (slice data), and thereafter, while sequentially shaping sectional members (layers) corresponding to the respective two-dimensional sectional layer data, the sectional members are sequentially stacked, whereby a three-dimensional shaped article is formed, has attracted attention.

The stacking method can immediately form a three-dimensional shaped article as long as there is model data of a three-dimensional shaped article to be shaped, and it is not necessary to form a mold or the like prior to shaping, and therefore, it is possible to rapidly form a three-dimensional shaped article at low cost. Further, since the formation is performed by staking layers of thin plate-shaped sectional members one by one, even a complicated object having, for example, an internal structure can be formed as an integrated shaped article without being divided into a plurality of components.

As a production method for a three-dimensional shaped article, there is a method using a composition containing particles and a solvent for dispersing the particles (see, for example, JP-A-2008-184622).

According to such a method, particles sometimes undesirably aggregated during storage or the like of the composition. Further, for the purpose of preventing undesirable aggregation of the particles, it is also considered that the content ratio of the particles in the composition is decreased, however, in such a case, the fluidity of the composition becomes too high, and the stability of the shape of a layer to be formed using the composition is deteriorated, and the dimensional accuracy of a three-dimensional shaped article to be produced is significantly deteriorated.

An object of the invention is to provide a three-dimensional shaped article producing composition that can be used for producing a three-dimensional shaped article having excellent dimensional accuracy and reliability with high productivity, to provide a production method for a three-dimensional shaped article that can produce a three-dimensional shaped article having excellent dimensional accuracy and reliability with high productivity, and also to provide a three-dimensional shaped article production apparatus that can produce a three-dimensional shaped article having excellent dimensional accuracy and reliability with high productivity.

### SUMMARY

Such an object is achieved by the following invention.

A three-dimensional shaped article producing composition of the invention is a three-dimensional shaped article producing composition used for producing a three-dimensional shaped article, and is characterized by containing a plurality of particles, a solvent for dispersing the particles, and nanocellulose.

According to this, a three-dimensional shaped article producing composition that can be used for producing a three-dimensional shaped article having excellent dimensional accuracy and reliability with high productivity can be provided.

In the three-dimensional shaped article producing composition of the invention, it is preferred that the nanocellulose covers the surfaces of the particles.

According to this, when the hardness of the particles is relatively high (for example, when the particles are constituted by a metal material or a ceramic material, or the like), a coating layer formed of the nanocellulose functions as a cushioning layer, and for example, can effectively prevent and suppress abrasion of the ejection portion (particularly, a nozzle of a piston-type dispenser or an inkjet) of the three-dimensional shaped article producing composition, and stable ejection of the three-dimensional shaped article producing composition can be performed over a long period of time. Further, the effect of the nanocellulose as a binder is more effectively exhibited.

In the three-dimensional shaped article producing composition of the invention, it is preferred that the solvent contains a polyhydric alcohol.

According to this, the ejectability of the three-dimensional shaped article producing composition can be enhanced. Further, the affinity of the nanocellulose for the solvent can be improved, and for example, when the nanocellulose at least partially covers the surfaces of the particles in the three-dimensional shaped article producing composition, the dispersibility of the particles in the three-dimensional shaped article producing composition can be improved.

In the three-dimensional shaped article producing composition of the invention, it is preferred that a content ratio of the nanocellulose is 0.02 vol % or more and 0.42 vol % or less.

According to this, the preservability and ejectability of the three-dimensional shaped article producing composition can be further improved, and also the dimensional accuracy of the three-dimensional shaped article can be further improved. In addition, the nanocellulose can be more reliably prevented from undesirably remaining in the final three-dimensional shaped article.

In the three-dimensional shaped article producing composition of the invention, it is preferred that the particles contain at least one of a metal material and a ceramic material.

According to this, for example, the texture (high-quality texture), mechanical strength, durability, and the like of the three-dimensional shaped article can be further improved. In addition, the dimensional accuracy of the three-dimensional shaped article can be more reliably improved while more reliably preventing the binder from remaining in the three-dimensional shaped article.

A production method for a three-dimensional shaped article of the invention is characterized by repeatedly performing a series of steps including a layer forming step of forming a layer using the three-dimensional shaped article producing composition of the invention, and a solvent removing step of removing the solvent contained in the layer.

According to this, a production method for a three-dimensional shaped article that can be used for producing a three-dimensional shaped article having excellent dimensional accuracy and reliability with high productivity can be provided.

In the production method for a three-dimensional shaped article of the invention, it is preferred that the layer forming step includes a first pattern forming step of forming a first pattern and a second pattern forming step of forming a second pattern, and the three-dimensional shaped article producing composition is used in at least one of the first pattern forming step and the first pattern forming step.

According to this, the dimensional accuracy and reliability of the three-dimensional shaped article can be further improved.

In the production method for a three-dimensional shaped article of the invention, it is preferred that the method includes a joining step of performing a joining treatment for joining the particles to one another after repeatedly performing the series of steps.

According to this, a three-dimensional shaped article having particularly excellent properties such as mechanical strength can be obtained. In addition, the productivity of the three-dimensional shaped article can be further improved.

In the production method for a three-dimensional shaped article of the invention, it is preferred that the three-dimensional shaped article producing composition is ejected by a dispenser.

According to this, the three-dimensional shaped article producing composition can be ejected with higher stability, and also the three-dimensional shaped article producing composition having a relatively high viscosity can be used, and therefore, the stability of the shape of the layer is also improved, and the dimensional accuracy of the three-dimensional shaped article to be finally obtained can be further improved.

A three-dimensional shaped article production apparatus of the invention is characterized by including a nozzle ejecting the three-dimensional shaped article producing composition of the invention, and forming a layer by ejecting the three-dimensional shaped article producing composition from the nozzle and producing a three-dimensional shaped article by stacking the layer.

According to this, a three-dimensional shaped article production apparatus that can be used for producing a three-dimensional shaped article having excellent dimensional accuracy and reliability with high productivity can be provided.

### BRIEF DESCRIPTION OF THE DRAWINGS

FIG. 1 is a vertical sectional view schematically showing a step (first pattern forming step) of a production method for a three-dimensional shaped article of a preferred embodiment of the invention.

FIG. 2 is a vertical sectional view schematically showing a step (second pattern forming step) of the production method for a three-dimensional shaped article of the preferred embodiment of the invention.

FIG. 3 is a vertical sectional view schematically showing a step (solvent removing step) of the production method for a three-dimensional shaped article of the preferred embodiment of the invention.

FIG. 4 is a vertical sectional view schematically showing a step (first pattern forming step) of the production method for a three-dimensional shaped article of the preferred embodiment of the invention.

FIG. 5 is a vertical sectional view schematically showing a step (second pattern forming step) of the production method for a three-dimensional shaped article of the preferred embodiment of the invention.

FIG. 6 is a vertical sectional view schematically showing a step (solvent removing step) of the production method for a three-dimensional shaped article of the preferred embodiment of the invention.

FIG. 7 is a vertical sectional view schematically showing a step of the production method for a three-dimensional shaped article of the preferred embodiment of the invention.

FIG. 8 is a vertical sectional view schematically showing a step (binder removing step) of the production method for a three-dimensional shaped article of the preferred embodiment of the invention.

FIG. 9 is a vertical sectional view schematically showing a step (joining step) of the production method for a three-dimensional shaped article of the preferred embodiment of the invention.

FIG. 10 is a vertical sectional view schematically showing a step (support portion removing step) of the production method for a three-dimensional shaped article of the preferred embodiment of the invention.

FIG. 11 is a flowchart showing the production method for a three-dimensional shaped article of the preferred embodiment of the invention.

FIG. 12 is a side view schematically showing a preferred embodiment of a three-dimensional shaped article production apparatus.

### DETAILED DESCRIPTION

Hereinafter, preferred embodiments will be described in detail with reference to the accompanying drawings.

### Production Method for Three-Dimensional Shaped Article

First, a production method for a three-dimensional shaped article of the invention will be described.

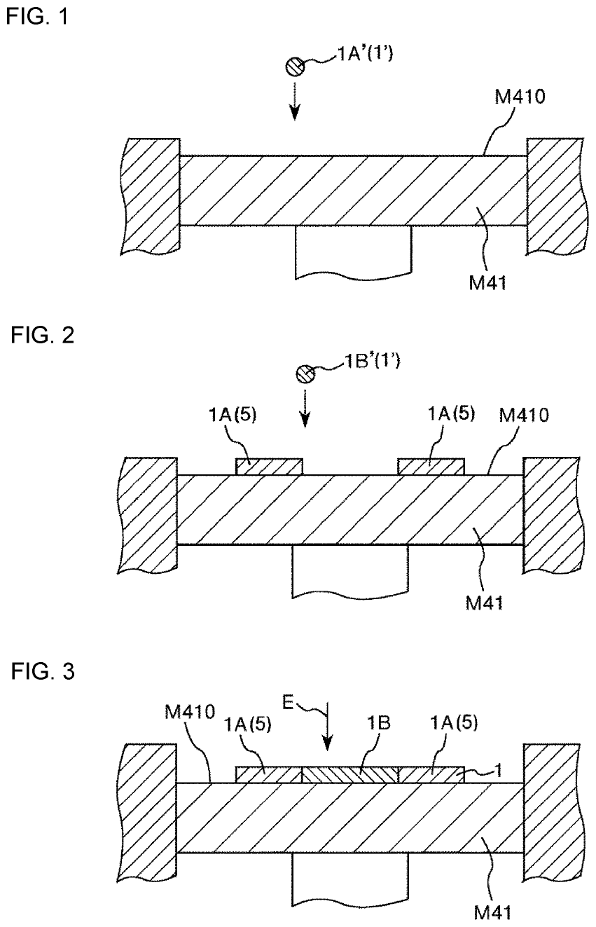

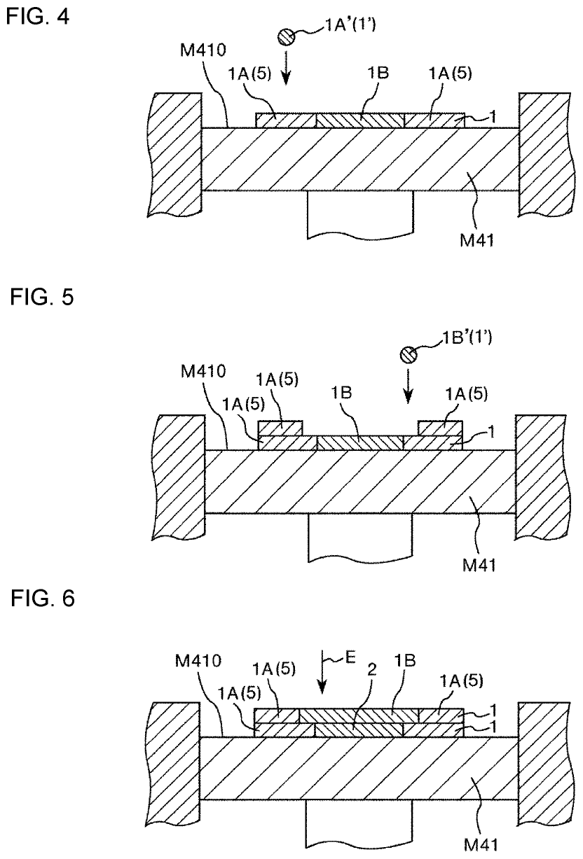

FIGS. 1 to 10 are vertical sectional views schematically showing steps of a production method for a three-dimensional shaped article of a preferred embodiment of the invention. FIG. is a flowchart showing the production method for a three-dimensional shaped article of a preferred embodiment of the invention.

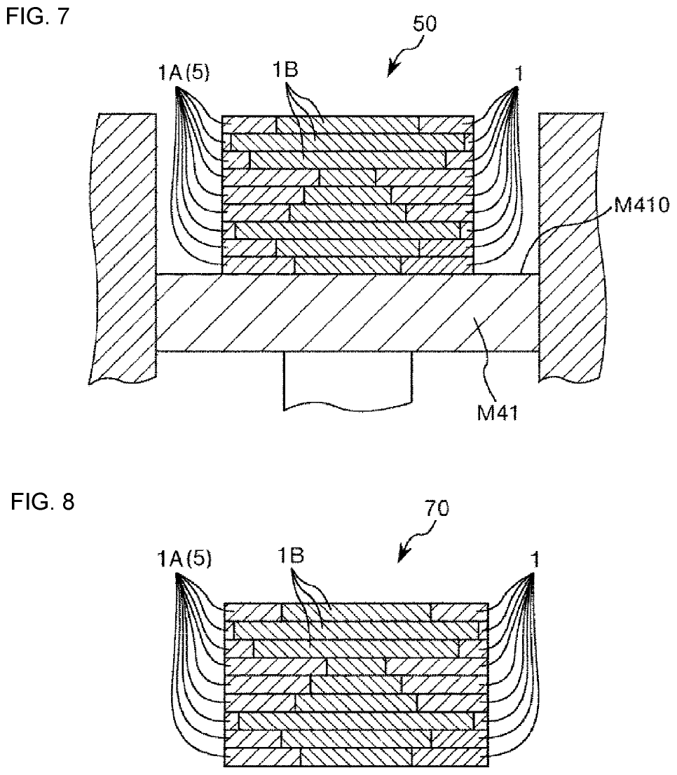

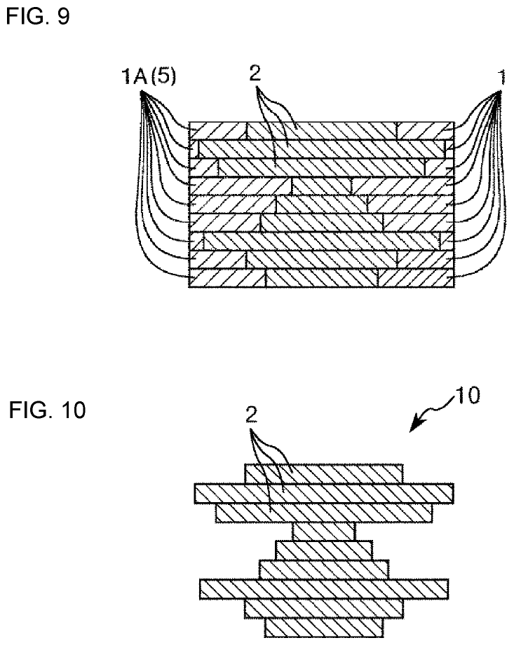

In a production method for a three-dimensional shaped article 10 of this embodiment, a series of steps including a layer forming step (see FIGS. 1, 2, 4, and 5) of forming a layer using a three-dimensional shaped article producing composition (layer forming composition) 1′, a solvent removing step (see FIGS. 3 and 6) of removing a solvent contained in the layer 1 is repeatedly performed thereby obtaining a stacked body 50 (see FIG. 7), and thereafter, for the stacked body 50, a joining step (see FIG. 9) of joining particles contained in the stacked body 50 (layer 1) to one another is performed.

Then, in the formation of the layer 1, the three-dimensional shaped article producing composition (layer forming composition) 1′ containing a plurality of particles (main material particles), a solvent for dispersing the particles, and nanocellulose is used.

According to this, a production method for the three-dimensional shaped article 10 that can produce a three-dimensional shaped article 10 having excellent dimensional accuracy and reliability with high productivity can be provided.

Incidentally, in the invention, the solvent is a liquid (dispersion medium) capable of dispersing particles and refers to a volatile liquid.

Particularly, in this embodiment, the layer forming step is performed using an entity portion forming composition 1B′ used for forming an entity portion (joined portion) 2 of the three-dimensional shaped article 10 and a support portion forming composition 1A′ used for forming a support portion (a supporting portion or a support material) 5 supporting a portion to become the entity portion 2 as the three-dimensional shaped article producing composition 1′, and includes a first pattern forming step (support portion pattern forming step) of forming a first pattern (support portion pattern) 1A′ by ejecting the support portion forming composition 1A′ and a second pattern forming step (entity portion pattern forming step) of forming a second pattern (entity portion pattern) 1B by ejecting the entity portion forming composition 1B′.

Then, at least one of the entity portion forming composition 1B′ and the support portion forming composition 1A′ as the three-dimensional shaped article producing composition (layer forming composition) 1′ contains a plurality of particles (main material particles), a solvent for dispersing the particles, and nanocellulose.

According to this, the dimensional accuracy and reliability of the three-dimensional shaped article can be further improved.

Hereinafter, the respective steps will be described in detail.

### First Pattern Forming Step

In the first pattern forming step, a first pattern 1A is formed by, for example, ejecting the support portion forming composition 1A′ on a plane M410 of a stage M41.

By forming the first pattern 1A by ejecting the support portion forming composition 1A′ in this manner, even a pattern having a fine shape or a complicated shape can be favorably formed.

When the support portion forming composition 1A′ contains a plurality of particles (main material particles), a solvent for dispersing the particles, and nanocellulose, in other words, when the support portion forming composition 1A′ is the three-dimensional shaped article producing composition of the invention, even if the content ratio of the solvent in the support portion forming composition 1A′ is relatively high, the viscosity of the support portion forming composition 1A′ can be easily adjusted to a favorable value, and the dispersion state of the particles or the like in the support portion forming composition 1A′ can be made favorable, so that an undesirable variation in formulation in the support portion forming composition 1A′ or an undesirable variation in formulation in the first pattern 1A formed by ejection can be effectively suppressed. Further, adhesion of a solid component to the nozzle ejecting the support portion forming composition 1A′ can be effectively prevented, and stable ejection of the support portion forming composition 1A′ can be performed over a long period of time.

A method for ejecting the support portion forming composition 1A′ is not particularly limited, and the ejection can also be performed using, for example, an inkjet apparatus or the like, but it is preferably ejected by a dispenser.

In this manner, by performing ejection of the support portion forming composition 1A′ using a dispenser, even the support portion forming composition 1A′ having a high viscosity can be favorably supplied (ejected), and dripping or the like of the support portion forming composition 1A′ after the support portion forming composition 1A′ comes in contact with a target site can be more effectively prevented. As a result, the dimensional accuracy of the three-dimensional shaped article 10 to be finally obtained can be further improved. In addition, by using the support portion forming composition 1A′ having a high viscosity, the layer 1 having a relatively large thickness can be easily formed, and the productivity of the three-dimensional shaped article 10 can be further improved.

Particularly, when the support portion forming composition 1A′ contains a plurality of particles (main material particles), a solvent for dispersing the particles, and nanocellulose, in other words, when the support portion forming composition 1A′ as the three-dimensional shaped article producing composition of the invention is ejected by a dispenser, the support portion forming composition 1A′ can be ejected with higher stability, and also the support portion forming composition 1A′ having a relatively high viscosity can be used, and therefore, the stability of the shape of the layer is also improved, and the dimensional accuracy of the three-dimensional shaped article 10 to be finally obtained can be further improved.

The support portion forming composition 1A′ may be in the form of, for example, a paste.

The viscosity of the support portion forming composition 1A′ in this step is preferably 100 mPa·s or more and 1,000,000 mPa·s or less, more preferably 500 mPa·s or more and 100,000 mPa·s or less, further more preferably 1,000 mPa·s or more and 20,000 mPa·s or less.

According to this, for example, the ejection stability of the support portion forming composition 1A′ can be further improved, and also the composition is suitable for forming the layer 1 having a moderate thickness, and the productivity of the three-dimensional shaped article 10 can be further improved. In addition, the excessive wet-spreading of the support portion forming composition 1A′ coming in contact with the adherend is more effectively prevented, and the dimensional accuracy of the three-dimensional shaped article 10 to be finally obtained can be further improved. Since the support portion forming composition 1A′ is the three-dimensional shaped article producing composition of the invention (the three-dimensional shaped article producing composition containing nanocellulose), such a viscosity can be easily and reliability realized while relatively increasing the content ratio of the solvent that is easily removed in the later step.

Incidentally, in this description, the viscosity refers to a value measured using a rheometer under the condition that the shear rate is 10 [s⁻¹] unless otherwise specified.

In this step, the support portion forming composition 1A′ may be ejected in the form of a continuous body or as a plurality of liquid droplets, but is preferably ejected as a plurality of liquid droplets.

According to this, for example, it can also be more favorably applied to the production of the three-dimensional shaped article 10 having a fine structure, and the dimensional accuracy of the three-dimensional shaped article 10 can be further improved.

When the support portion forming composition 1A′ is ejected as a plurality of liquid droplets in this step, the volume per liquid droplet to be ejected is preferably 1 pL or more and 100,000 pL (100 nL) or less, more preferably 10 pL or more and 5,000 pL (5 nL) or less.

According to this, for example, the composition can also be more favorably applied to the production of the three-dimensional shaped article 10 having a fine structure, and the dimensional accuracy of the three-dimensional shaped article 10 can be further improved, and also the productivity of the three-dimensional shaped article 10 can be further improved.

In the production of the three-dimensional shaped article 10, as the support portion forming composition 1A′, a plurality of types of compositions may be used.

Incidentally, the support portion forming composition 1A′ will be described in detail later.

### Second Pattern Forming Step

In the second pattern forming step, a second pattern 1B is formed by ejecting the entity portion forming composition 1B′.

By forming the second pattern 1B by ejecting the entity portion forming composition 1B′ in this manner, even a pattern having a fine shape or a complicated shape can be favorably formed.

Particularly, in this embodiment, the entity portion forming composition 1B′ is ejected in a region surrounded by the first pattern 1A so that the entire periphery of the second pattern 1B is in contact with the first pattern LA.

According to this, the dimensional accuracy of the three-dimensional shaped article 10 to be finally obtained can be further improved.

When the entity portion forming composition 1B′ contains a plurality of particles (main material particles), a solvent for dispersing the particles, and nanocellulose, in other words, when the entity portion forming composition 1B′ is the three-dimensional shaped article producing composition of the invention, even if the content ratio of the solvent in the entity portion forming composition 1B′ is relatively high, the viscosity of the entity portion forming composition 1B′ can be easily adjusted to a favorable value, and the dispersion state of the particles or the like in the entity portion forming composition 1B′ can be made favorable, so that an undesirable variation in formulation in the entity portion forming composition 1B′ or an undesirable variation in formulation in the second pattern 1B formed by ejection can be effectively suppressed. In addition, adhesion of a solid component to the nozzle ejecting the entity portion forming composition 1B′ can be effectively suppressed, and stable ejection of the entity portion forming composition 1B′ can be performed over a long period of time.

A method for ejecting the entity portion forming composition 1B′ is not particularly limited, and the ejection can also be performed using, for example, an inkjet apparatus or the like, but it is preferably ejected by a dispenser.

In this manner, by performing ejection of the entity portion forming composition 1B′ using a dispenser, even the entity portion forming composition 1B′ having a high viscosity can be favorably supplied (ejected), and dripping or the like of the entity portion forming composition 1B′ after the entity portion forming composition 1B′ comes in contact with a target site can be more effectively prevented. As a result, the dimensional accuracy of the three-dimensional shaped article 10 to be finally obtained can be further improved. In addition, by using the entity portion forming composition 1B′ having a high viscosity, the layer 1 having a relatively large thickness can be easily formed, and the productivity of the three-dimensional shaped article 10 can be further improved.

Particularly, when the entity portion forming composition 1B′ contains a plurality of particles (main material particles), a solvent for dispersing the particles, and nanocellulose, in other words, when the entity portion forming composition 1B′ as the three-dimensional shaped article producing composition of the invention is ejected by a dispenser, the entity portion forming composition 1B′ can be ejected with higher stability, and also the entity portion forming composition 1B′ having a relatively high viscosity can be used, and therefore, the stability of the shape of the layer 1 is also improved, and the dimensional accuracy of the three-dimensional shaped article 10 to be finally obtained can be further improved.

The entity portion forming composition 1B′ may be in the form of, for example, a paste.

The viscosity of the entity portion forming composition 1B′ in this step is preferably 100 mPa·s or more and 1,000,000 mPa·s or less, more preferably 500 mPa·s or more and 100,000 mPa·s or less, further more preferably 1,000 mPa·s or more and 20,000 mPa·s or less.

According to this, for example, the ejection stability of the entity portion forming composition 1B′ can be further improved, and also the composition is suitable for forming the layer 1 having a moderate thickness, and the productivity of the three-dimensional shaped article 10 can be further improved. In addition, the excessive wet-spreading of the entity portion forming composition 1B′ coming in contact with the adherend is more effectively prevented, and the dimensional accuracy of the three-dimensional shaped article 10 to be finally obtained can be further improved. Since the entity portion forming composition 1B′ is the three-dimensional shaped article producing composition of the invention (the three-dimensional shaped article producing composition containing nanocellulose), such a viscosity can be easily and reliability realized while relatively increasing the content ratio of the solvent that is easily removed in the later step.

In this step, the entity portion forming composition 1B′ may be ejected in the form of a continuous body or as a plurality of liquid droplets, but is preferably ejected as a plurality of liquid droplets.

According to this, for example, it can also be more favorably applied to the production of the three-dimensional shaped article 10 having a fine structure, and the dimensional accuracy of the three-dimensional shaped article 10 can be further improved.

When the entity portion forming composition 1B′ is ejected as a plurality of liquid droplets in this step, the volume per liquid droplet to be ejected is preferably 1 pL or more and 100,000 pL (100 nL) or less, more preferably 10 pL or more and 5,000 pL (5 nL) or less.

According to this, for example, the composition can also be more favorably applied to the production of the three-dimensional shaped article 10 having a fine structure, and the dimensional accuracy of the three-dimensional shaped article 10 can be further improved, and also the productivity of the three-dimensional shaped article 10 can be further improved.

In the production of the three-dimensional shaped article 10, as the entity portion forming composition 1B′, a plurality of types of compositions may be used.

By doing this, for example, materials can be combined according to the properties required for the respective portions of the three-dimensional shaped article 10, and therefore, the properties (including appearance, functionality (for example, elasticity, toughness, heat resistance, corrosion resistance, or the like), etc.) of the three-dimensional shaped article 10 as a whole can be further improved.

Incidentally, the entity portion forming composition 1B′ will be described in detail later.

By performing the first pattern forming step and the second pattern forming step as described above, the layer 1 having the first pattern 1A and the second pattern 1B is formed. In other words, the layer forming step includes the first pattern forming step and the second pattern forming step.

The thickness of each layer 1 formed using the support portion forming composition 1A′ and the entity portion forming composition 1B′ is not particularly limited, but is preferably 10 μm or more and 500 μm or less, more preferably 20 μm or more and 250 μm or less.

According to this, the dimensional accuracy of the three-dimensional shaped article 10 can be further improved while improving the productivity of the three-dimensional shaped article 10.

### Solvent Removing Step

In the solvent removing step, the solvent contained in the layer 1 is removed.

According to this, the fluidity of the layer 1 is decreased, and the stability of the shape of the layer 1 is improved. Particularly, at least one of the entity portion forming composition 1B′ and the support portion forming composition 1A′ contains nanocellulose. Therefore, by removing the solvent in this step, the nanocellulose can function as a binder for temporarily binding the particles to one another, and the stability of the shape of the layer 1 can be further improved. In addition, by including nanocellulose in the layer 1, also in the process for removing the solvent from the layer 1 in this step, the increasing ratio of the viscosity of the layer 1 accompanying the progress of removal of the solvent becomes particularly high. Therefore, undesirable deformation of the layer 1 in this step is also more effectively prevented. By synergistic action of these effects, the three-dimensional shaped article 10 having excellent dimensional accuracy can be obtained in the end. The effect as described above is more remarkably exhibited when both of the entity portion forming composition 1B′ and the support portion forming composition 1A′ contain nanocellulose.

As a method for removing the solvent, for example, heating of the layer 1, irradiation of the layer 1 with an infrared ray, placement of the layer 1 under reduced pressure, supply of a gas with a low liquid component content ratio (for example, a gas with a relative humidity of 30% or less) such as dry air, etc. are exemplified. Further, two or more methods selected from these may be performed in combination.

In the configuration shown in the drawing, the layer 1 is heated by supplying thermal energy E from a heating unit.

Further, in this embodiment, the solvent removing step (is not collectively performed for a plurality of layers 1, but) is performed for the respective layers 1 one after another. That is, the solvent removing step is included in the series of repeating steps including the layer forming step.

According to this, a relatively large amount of the solvent is more effectively prevented from undesirably remaining inside the stacked body 50 including a plurality of layers 1. As a result, the reliability of the three-dimensional shaped article 10 to be finally obtained can be further improved. In addition, in the stacked body 50 obtained by stacking the layers 1, the occurrence of undesirable deformation can be more effectively prevented.

Incidentally, in this step, it is not necessary to completely remove the solvent contained in the layer 1. Also in such a case, the remaining solvent can be sufficiently removed in the later step. Such a case also includes a state where by volatilization of the solvent, the amount of the dissolved binder with respect to the amount of the solvent contained in the layer 1 is relatively increased, so that the function to temporarily bind the particles to one another is exhibited.

The content ratio of the solvent in the layer 1 after this step is preferably 0.1 mass % or more and 25 mass % or less, more preferably 0.5 mass % or more and 20 mass % or less.

According to this, undesirable deformation involved in sudden volatilization (explosive boil or the like) or the like of the solvent in the later step is effectively prevented, the three-dimensional shaped article 10 having excellent dimensional accuracy can be more reliably obtained, and the reliability of the three-dimensional shaped article 10 can be further improved, and also the productivity of the three-dimensional shaped article 10 can be further improved.

In the production of the three-dimensional shaped article 10, a series of steps including the layer forming step (the first pattern forming step and the second pattern forming step) and the solvent removing step is repeatedly performed as many times as specified, whereby the stacked body 50 in which a plurality of layers 1 are stacked is obtained (see FIG. 7).

That is, it is determined whether a new layer 1 should be formed on the already formed layer 1, and when there is a layer 1 that should be formed, a new layer 1 is formed, and when there is no layer 1 that should be formed, a step described in detail later is performed for the stacked body 50.

### Binder Removing Step

In this embodiment, a binder removing step of performing a binder removing treatment for removing a component having a function as a binder for the stacked body 50 obtained by repeatedly performing the series of steps including the layer forming step (the first pattern forming step and the second pattern forming step) and the solvent removing step as described above is included (see FIG. 8). According to this, a binder removed body 70 is obtained. By obtaining such a binder removed body 70, the subsequent sintering step (joining step) can be more favorably performed.

Further, in the stacked body 50 to be subjected to this step, the content ratio of the solvent becomes sufficiently low by the above-mentioned solvent removing step, and therefore, undesirable deformation (for example, deformation or the like involved in sudden volatilization of the solvent) in the binder removing step is effectively prevented.

Further, for example, by performing the binder removing step, the binder (including nanocellulose) or a decomposition product thereof can be more effectively prevented from undesirably remaining in the three-dimensional shaped article 10 to be finally obtained.

Incidentally, in this description, the binder removed body refers to a material obtained by performing a treatment (binder removing treatment) for removing the binder for the molded body (stacked body 50) molded into a predetermined shape. In the binder removing treatment, it is sufficient that at least a part of the binder (including nanocellulose) contained in the molded body (stacked body 50) is removed, and a part of the binder may remain in the binder removed body 70.

Particularly, by forming the layer 1 using the three-dimensional shaped article producing composition of the invention (a composition containing a plurality of particles (main material particles), a solvent for dispersing the particles, and nanocellulose), the amount of the binder in the three-dimensional shaped article producing composition can be relatively reduced, and therefore, in this step, the binder (including nanocellulose) can be efficiently removed in a short time. Further, even when the condition for the binder removing treatment is relaxed, the binder can be efficiently removed. As a result, the reliability of the three-dimensional shaped article 10 can be improved while improving the productivity of the three-dimensional shaped article 10.

The binder removing treatment may be performed by any method as long as it is a method for removing the binder contained in the stacked body 50, but is performed by performing a heat treatment in an oxidizing atmosphere of oxygen, nitric acid gas, or the like, or other than this, in a non-oxidizing atmosphere, for example, under vacuum or in a reduced pressure state (for example, 1.33×10⁻⁴ Pa or more and 13.3 Pa or less), or in a gas such as nitrogen gas or argon gas.

Further, a treatment temperature in the binder removing step (heat treatment) is not particularly limited, but is preferably 100° C. or higher and 750° C. or lower, more preferably 150° C. or higher and 600° C. or lower.

According to this, undesirable deformation of the stacked body 50 in the binder removing step and the binder removed body 70 can be more reliably prevented, and the binder removing treatment can be made to more efficiently proceed. As a result, the three-dimensional shaped article 10 having more excellent dimensional accuracy can be produced with higher productivity.

Further, a treatment time (heat treatment time) in the binder removing step (heat treatment) is preferably 0.5 hours or more and 10 hours or less, more preferably 1 hour or more and 5 hours or less.

According to this, the productivity of the three-dimensional shaped article 10 can be further improved. In addition, the residual ratio of the binder in the binder removed body 70 can be sufficiently decreased, and the reliability of the three-dimensional shaped article 10 to be finally obtained can be further improved.

Further, the removal of the binder by such a heat treatment may be performed by dividing the step into a plurality of steps (stages) for various purposes (for example, for the purpose of reducing the treatment time or the like). In that case, for example, a method in which the first half of the treatment is performed at a low temperature and the second half of the treatment is performed at a high temperature, a method in which a treatment at a low temperature and a treatment at a high temperature are repeatedly performed, etc. are exemplified.

### Sintering Step (Joining Step)

In this embodiment, a sintering step as a joining step of performing a joining treatment for joining the particles (main material particles) contained in the binder removed body 70 obtained in the binder removing step to one another is included.

According to this, the particles contained in the binder removed body 70 are joined (sintered) to one another so as to form forming a joined portion (entity portion) 2, whereby the three-dimensional shaped article 10 as a sintered body is produced (see FIG. 9).

By forming the joined portion 2 in this manner, the three-dimensional shaped article 10 having a structure in which the particles are firmly joined and thus having particularly excellent properties such as mechanical strength can be obtained.

Further, even when the binder remains up to the above-mentioned step, the binder can be reliably removed by the joining treatment (sintering treatment). As a result, the binder can be prevented from undesirably remaining in the three-dimensional shaped article 10, and the reliability of the three-dimensional shaped article 10 can be further enhanced.

Particularly, in this embodiment, the joining treatment is performed for the stacked body (binder removed body 70) including a plurality of layers 1. In other words, in this embodiment, the joining step of performing the joining treatment for joining the particles to one another is included after repeatedly performing the above-mentioned series of steps.

According to this, the productivity of the three-dimensional shaped article 10 can be further improved.

The sintering step is performed by a heating treatment.

Heating in the sintering step is preferably performed at a temperature not higher than the melting point of the constituent material of the particles constituting the binder removed body 70.

According to this, joining of the particles can be more efficiently performed without destroying the shape of the stacked body.

The heating treatment in the sintering step is generally performed at a higher temperature than the heating treatment in the binder removing step.

When the melting point of the constituent material of the particles is represented by Tm [° C.], the heating temperature in the sintering step is preferably (Tm-200°) C. or higher and (Tm-50°) C. or lower, more preferably (Tm-150°) C. or higher and (Tm-70°) C. or lower.

According to this, joining of the particles can be more efficiently performed by the heating treatment in a shorter time, and also undesirable deformation of the binder removed body 70 in the sintering step can be more effectively prevented, and the dimensional accuracy of the three-dimensional shaped article 10 can be further improved.

Incidentally, when the particles contain a plurality of components, the melting point of a component whose content ratio is highest can be adopted as the melting point.

A heating time in the sintering step is not particularly limited, but is preferably 30 minutes or more and 5 hours or less, more preferably 1 hour or more and 3 hours or less.

According to this, undesirable deformation in this step can be more effectively prevented while allowing the joining of the particles to one another to sufficiently proceed, and thus, the mechanical strength and the dimensional accuracy of the three-dimensional shaped article 10 can be made compatible at a higher level, and also the productivity of the three-dimensional shaped article 10 can be further improved.

Further, an atmosphere in the sintering treatment is not particularly limited, however, a non-oxidizing atmosphere, for example, under vacuum or in a reduced pressure state (for example, 1.33×10⁻⁴ Pa or more and 133 Pa or less), or in an inert gas such as nitrogen gas or argon gas, or according to need, in an atmosphere of a reducing gas such as hydrogen can be adopted.

Further, the sintering step may be performed by being divided into two or more stages. According to this, the sintering efficiency is improved, and sintering (firing) can be performed in a shorter treatment time.

Further, the sintering step may be performed continuously with the above-mentioned binder removing step.

According to this, the binder removing step can also serve as a pre-sintering step so as to preheat the binder removed body 70, and thus, the binder removed body 70 can be more reliably sintered.

Further, such a sintering step may be performed by being divided into a plurality of steps (stages) for various purposes (for example, for the purpose of reducing the firing time or the like). In that case, for example, a method in which the first half of firing is performed at a low temperature and the second half of firing is performed at a high temperature, a method in which firing at a low temperature and firing at a high temperature are repeatedly performed, etc. are exemplified.

### Support Portion Removing Step

Thereafter, as a post-treatment, the support portion 5 (the first pattern 1A formed in the first pattern forming step) is removed. By doing this, the three-dimensional shaped article 10 is taken out (see FIG. 10).

As a specific method of this step, for example, a method in which the support material 5 is mechanically destroyed, a method in which the support material 5 is chemically decomposed, a method in which the support material 5 is dissolved, a method in which the support material 5 is brushed off with a brush or the like, a method in which the support material 5 is removed by suction, a method in which a gas such as air is blown thereto, a method in which a liquid such as water is applied thereto (for example, a method in which a composite of the support portion 5 and the binder removed body 70 obtained as described above is soaked in a liquid, a method in which a liquid is sprayed thereto, etc.), a method in which vibration such as ultrasonic vibration is applied thereto, etc. are exemplified. Further, two or more methods selected from these can be performed in combination.

Incidentally, when the support portion removing step is performed before the above-mentioned sintering step, the sintering step can also be performed in a state of being buried in the support material in the form of a powder.

According to the production method as described above, the three-dimensional shaped article 10 having excellent dimensional accuracy and reliability can be efficiently produced.

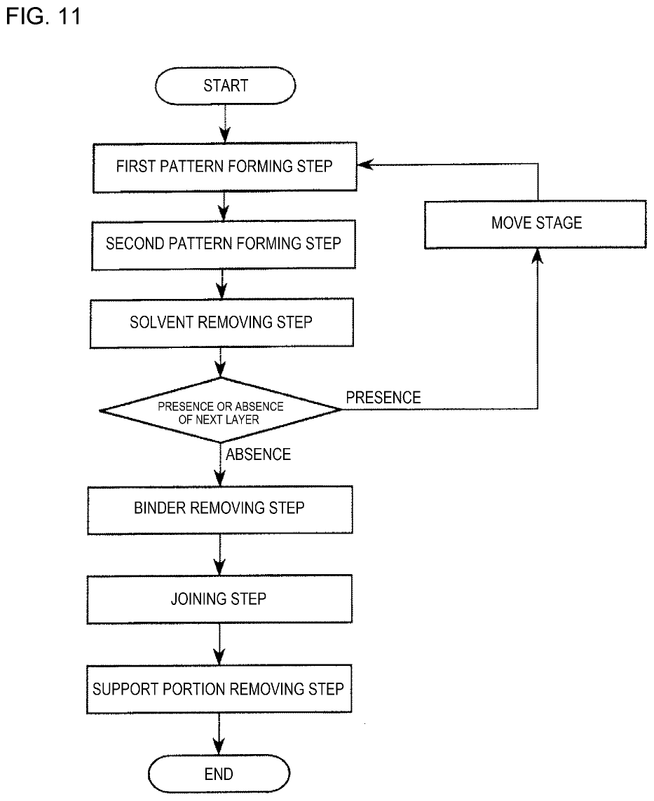

The production method for the three-dimensional shaped article 10 as described above can be summarized in a flowchart as shown in FIG. 11.

### Three-Dimensional Shaped Article Producing Composition

Next, the three-dimensional shaped article producing composition of the invention will be described.

When a plurality of types of three-dimensional shaped article producing compositions are used in the production of the three-dimensional shaped article, at least one type of three-dimensional shaped article producing composition may be the three-dimensional shaped article producing composition of the invention (a composition containing a plurality of particles, a solvent for dispersing the particles, and nanocellulose).

In this embodiment, as the three-dimensional shaped article producing composition, the entity portion forming composition 1B′ and the support portion forming composition 1A′ are used.

### Entity Portion Forming Composition

First, the entity portion forming composition 1B′ as the three-dimensional shaped article producing composition used for producing the three-dimensional shaped article 10 will be described.

The constituent component or the like of the entity portion forming composition 1B′ is not particularly limited as long as the composition can be used for forming the entity portion 2 (forming the second pattern 1B), however, the composition preferably contains a plurality of particles (main material particles) and a solvent for dispersing the particles, and more preferably further contains nanocellulose.

In the following description, a case where the entity portion forming composition 1B′ contains a plurality of particles, a solvent, and nanocellulose will be representatively described.

### Particles

By including a plurality of particles in the entity portion forming composition 1B′, the range of choice of the constituent material of the three-dimensional shaped article 10 can be expanded, and the three-dimensional shaped article 10 having desired physical properties, texture, and the like can be favorably obtained. For example, when the three-dimensional shaped article is produced using a material dissolved in a solvent, there are limitations on the material that can be used, however, by using the entity portion forming composition 1B′ containing particles, such limitations can be eliminated.

As the constituent material of the particles contained in the entity portion forming composition 1B′, for example, a metal material, a metal compound (a ceramic or the like), a resin material, a pigment, etc. are exemplified.

The entity portion forming composition 1B′ preferably contains particles constituted by a material containing at least one of a metal material and a ceramic material.

According to this, for example, the texture (high-quality texture), mechanical strength, durability, and the like of the three-dimensional shaped article 10 can be further improved. In addition, these materials generally have sufficient shape stability at a decomposition temperature of the binder (including nanocellulose) as described in detail later. Therefore, in the production process for the three-dimensional shaped article 10, the binder is reliably removed, and the dimensional accuracy of the three-dimensional shaped article 10 can be more reliably improved while more reliably preventing the binder from remaining in the three-dimensional shaped article 10.

Particularly, when the particles are constituted by a material containing a metal material, the high-quality texture, massive texture, mechanical strength, toughness, and the like of the three-dimensional shaped article 10 are further improved. In addition, heat transfer when energy for joining the particles is applied efficiently proceeds, and therefore, while improving the productivity of the three-dimensional shaped article 10, the occurrence of an undesirable variation in temperature at the respective sites can be more effectively prevented, and the reliability of the three-dimensional shaped article 10 can be further improved. In addition, for example, in a case of metal particles having a hydroxy group or a carboxyl group on the surfaces thereof, binding of the hydroxy group or the carboxyl group of nanocellulose to the metal particles is further improved, and a structure in which the nanocellulose covers the surfaces of the particles as described later can be favorably formed.

As the metal material constituting the particles, for example, magnesium, iron, copper, cobalt, titanium, chromium, nickel, aluminum, an alloy containing at least one type among these (for example, a maraging steel, a stainless steel, cobalt-chromium-molybdenum, a titanium alloy, a nickel-based alloy, an aluminum alloy, or the like), etc. are exemplified.

As the metal compound constituting the particles, for example, various metal oxides such as silica, alumina, titanium oxide, zinc oxide, zirconium oxide, tin oxide, magnesium oxide, and potassium titanate; various metal hydroxides such as magnesium hydroxide, aluminum hydroxide, and calcium hydroxide; various metal nitrides such as silicon nitride, titanium nitride, and aluminum nitride; various metal carbides such as silicon carbide and titanium carbide; various metal sulfides such as zinc sulfide; various metal carbonates such as calcium carbonate and magnesium carbonate; various metal sulfates such as calcium sulfate and magnesium sulfate; various metal silicates such as calcium silicate and magnesium silicate; various metal phosphates such as calcium phosphate; various metal borates such as aluminum borate and magnesium borate; composites of these materials; etc. are exemplified.

As the resin material constituting the particles, for example, polybutylene terephthalate, polyethylene terephthalate, polypropylene, polystyrene, syndiotactic polystyrene, polyacetal, modified polyphenylene ether, polyether ether ketone, polycarbonate, an acrylonitrile-butadiene-styrene copolymer (ABS resin), polyether nitrile, a polyamide (nylon or the like), polyarylate, polyamideimide, polyetherimide, polyimide, a liquid crystalline polymer, polysulfone, polyethersulfone, polyphenylene sulfide, a fluororesin, etc. are exemplified.

The shape of the particle is not particularly limited, and may be any shape such as a spherical shape, a spindle shape, a needle shape, a cylindrical shape, or a flaky shape, and further, it may be an irregular shape, but is preferably a spherical shape.

The average particle diameter of the particles is not particularly limited, but is preferably 0.1 μm or more and 20 μm or less, more preferably 0.2 μm or more and 10 μm or less.

According to this, the fluidity of the entity portion forming composition 1B′ becomes more favorable, and therefore, the second pattern forming step can be more smoothly performed, and also the joining of the particles in the joining step can be more favorably performed. Further, for example, the removal or the like of the solvent, the binder, or the like contained in the layer 1 can be efficiently performed, and the constituent materials other than the particles can be more effectively prevented from undesirably remaining in the final three-dimensional shaped article 10. As a result, while further improving the productivity of the three-dimensional shaped article 10, the reliability and mechanical strength of the three-dimensional shaped article 10 to be produced can be further improved, and the occurrence of undesirable irregularities or the like in the three-dimensional shaped article 10 to be produced can be more effectively prevented, and the dimensional accuracy of the three-dimensional shaped article 10 can be further improved.

Incidentally, in the invention, the average particle diameter refers to a volume-based average particle diameter and can be determined by, for example, subjecting a dispersion liquid obtained by adding a sample to methanol and dispersing the sample therein for 3 minutes with an ultrasonic disperser to measurement by a particle size distribution analyzer employing a Coulter counter method (model TA-II, manufactured by COULTER ELECTRONICS INS) using an aperture of 50 μm.

The Dmax of the particles is preferably 0.2 μm or more and 25 μm or less, more preferably 0.4 μm or more and 15 μm or less.

According to this, the fluidity of the entity portion forming composition 1B′ becomes more favorable, and therefore, the second pattern forming step can be more smoothly performed, and also the joining of the particles in the joining step can be more favorably performed. As a result, while further improving the productivity of the three-dimensional shaped article 10, the mechanical strength of the three-dimensional shaped article 10 to be produced can be further improved, and the occurrence of undesirable irregularities or the like in the three-dimensional shaped article 10 to be produced can be more effectively prevented, and the dimensional accuracy of the three-dimensional shaped article 10 can be further improved.

The content ratio of the particles in the entity portion forming composition 1B′ is preferably 30 mass % or more and 93 mass % or less, more preferably 35 mass % or more and 88 mass % or less.

According to this, while further improving the ease of handling of the entity portion forming composition 1B′, the amount of components to be removed in the production process for the three-dimensional shaped article 10 can be further reduced, and therefore, it is particularly advantageous in terms of the productivity of the three-dimensional shaped article 10, the production cost thereof, saving resources, and the like. In addition, the dimensional accuracy of the three-dimensional shaped article 10 to be finally obtained can be further improved.

Incidentally, the particles are constituted by a material to undergo a chemical reaction (for example, an oxidation reaction or the like) in the production process for the three-dimensional shaped article 10 (for example, the joining step or the like), and the formulation of the particles contained in the entity portion forming composition 1B′ may be different from the formulation of the constituent material of the final three-dimensional shaped article 10.

Further, the entity portion forming composition 1B′ may contain two or more types of particles.

### Solvent

By including the solvent in the entity portion forming composition 1B′, the particles can be favorably dispersed in the entity portion forming composition 1B′, and the ejection of the entity portion forming composition 1B′ by a dispenser or the like can be stably performed.

The solvent is not particularly limited as long as it has a function (a function as the dispersion medium) to disperse the particles in the entity portion forming composition 1B′, however, for example, water; (poly)alkylene glycol monoalkyl ethers such as ethylene glycol monomethyl ether, ethylene glycol monoethyl ether, propylene glycol monomethyl ether, and propylene glycol monoethyl ether; acetate esters such as ethyl acetate, n-propyl acetate, iso-propyl acetate, n-butyl acetate, and iso-butyl acetate; carbitols such as carbitol and an ester compound thereof (for example, carbitol acetate or the like); cellosolves such as cellosolve and an ester compound thereof (for example, cellosolve acetate or the like); aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as monohydric alcohols such as ethanol, propanol, and butanol, and polyhydric alcohols such as ethylene glycol, propylene glycol, dipropylene glycol, butanediol, glycerin, and 1,3-butylene glycol; sulfoxide-based solvents such as dimethyl sulfoxide and diethyl sulfoxide; pyridine-based solvents such as pyridine, picoline (α-picoline, β-picoline, and γ-picoline), and 2,6-lutidine; and ionic liquids such as a tetraalkylammonium acetate (for example, tetrabutylammonium acetate or the like); etc. are exemplified, and one type or two or more types in combination selected from these can be used.

Above all, the solvent preferably contains a polyhydric alcohol.

According to this, the ejectability of the entity portion forming composition 1B′ can be further enhanced. In addition, the affinity of the nanocellulose for the solvent can be improved, and for example, when the nanocellulose at least partially covers the surfaces of the particles in the entity portion forming composition 1B′, the dispersibility of the particles in the entity portion forming composition 1B′ can be improved.

Particularly, the polyhydric alcohol is preferably selected from ethylene glycol, propylene glycol, dipropylene glycol, butanediol, glycerin, and 1,3-butylene glycol.

The content of the solvent in the entity portion forming composition 1B′ is preferably 5 mass % or more and 68 mass % or less, more preferably 8 mass % or more and 60 mass % or less.

According to this, while further improving the ease of handling of the entity portion forming composition 1B′, the productivity of the three-dimensional shaped article 10 can be further improved, and also it is particularly advantageous also in terms of the production cost, saving resources, and the like. Further, the dimensional accuracy of the three-dimensional shaped article 10 to be finally obtained can be further improved.

### Nanocellulose

The nanocellulose is a fibrous material that is constituted by cellulose or a derivative of cellulose and that has a width and a thickness of 100 nm or less, and is a concept including a so-called cellulose nanofiber or cellulose nanocrystal.

By including such nanocellulose, the viscosity of the entire entity portion forming composition 1B′ can be adjusted within a favorable range at a relatively low content ratio. As a result, for example, even if the content ratio of the particles or the content ratio of the binder other than the nanocellulose in the entity portion forming composition 1B′ is not set high, the viscosity of the entity portion forming composition 1B′ can be sufficiently increased. Therefore, undesirable deformation of the layer 1 can be prevented while effectively preventing undesirable aggregation of the particles in the entity portion forming composition 1B′ or an undesirable variation in formulation or the like in the entity portion forming composition 1B′ or in the three-dimensional shaped article 10. On the other hand, the entity portion forming composition 1B′ containing nanocellulose has thixotropy, and the viscosity of the entity portion forming composition 1B′ decreases in a state where shear stress is applied as when the composition is ejected, and stable ejection can be performed. Further, the amount of the binder contained in the entity portion forming composition 1B′ can be reduced, and therefore, the binder removing treatment can be efficiently performed in a short time, and the three-dimensional shaped article 10 can be produced with high productivity, and also the binder or a decomposition product thereof or the like can be effectively prevented from undesirably remaining in the three-dimensional shaped article 10 to be finally obtained. Further, for the above reasons, the three-dimensional shaped article 10 having excellent dimensional accuracy and reliability can be obtained. In addition, the nanocellulose can function as a reduced carbon source in the binder removing step or the joining step, and for example, even if the particles are constituted by a metal material or the like that is easily oxidized, the progress of an undesirable oxidation reaction in the production process for the three-dimensional shaped article 10 can be more effectively prevented.

The width and thickness of the nanocellulose may be 100 nm or less, but is preferably 1 nm or more and 80 nm or less, more preferably 4 nm or more and 70 nm or less, further more preferably 10 nm or more and 50 nm or less.

According to this, an effect as described above is more remarkably exhibited.

The length of the nanocellulose is not particularly limited, but is preferably 100 nm or more, more preferably 100 nm or more and 50 μm or less, further more preferably 150 nm or more and 30 μm or less.

According to this, an effect as described above is more remarkably exhibited.

Further, the aspect ratio of a fiber of the nanocellulose is preferably 3 or more and 2,000 or less, more preferably 5 or more and 1,000 or less, further more preferably 7 or more and 600 or less.

According to this, an effect as described above is more remarkably exhibited.

The nanocellulose may be present independently of the particles, but preferably covers the surfaces of the particles in the entity portion forming composition 1B′.

According to this, when the hardness of the particles is relatively high (for example, when the particles are constituted by a metal material or a ceramic material, or the like), a coating layer formed of the nanocellulose functions as a cushioning layer, and for example, can effectively prevent and suppress abrasion of the ejection portion (particularly, a nozzle of a piston-type dispenser or an inkjet) of the entity portion forming composition 1B′, and stable ejection of the entity portion forming composition 1B′ can be performed over a long period of time. Further, the effect of the nanocellulose as the binder is more effectively exhibited.

When the surfaces of the particles are covered with the nanocellulose, the coverage of the surfaces of the particles with the nanocellulose is preferably 20% or more and 100% or less, more preferably 50% or more and 100% or less, further more preferably 80% or more and 100% or less.

According to this, an effect as described above is more remarkably exhibited.

The content ratio of the nanocellulose in the entity portion forming composition 1B′ is preferably 0.02 vol % or more and 0.42 vol % or less, more preferably 0.04 vol % or more and 0.40 vol % or less, further more preferably 0.06 vol % or more and 0.38 vol % or less.

According to this, the preservability and ejectability of the entity portion forming composition 1B′ can be further improved, and also the dimensional accuracy of the three-dimensional shaped article 10 can be further improved. In addition, the nanocellulose can be more reliably prevented from undesirably remaining in the final three-dimensional shaped article 10. Further, a phenomenon in which fibrillization occurs when the composition is ejected can be suppressed.

### Other Binder

As described above, the nanocellulose also has a function as a binder for temporarily binding the particles to one another in a state where the solvent is removed (a function to temporarily bind the particles to one another in the layer 1 in a state where the solvent is removed), however, the entity portion forming composition 1B′ may further contain a component functioning as a binder other than the nanocellulose (hereinafter also referred to as “other binder”).

According to this, a strength to temporarily bind the particles to one another in a state where the solvent is removed can be enhanced, and undesirable scattering or the like of the particles can be more effectively prevented.

As the other binder, for example, various resin materials such as a thermoplastic resin and a curable resin, and the like can be used.

When a curable resin is contained, a curing reaction of the curable resin may be performed at a timing after ejection of the entity portion forming composition 1B′ and before the joining step.

According to this, undesirable deformation of the pattern formed using the entity portion forming composition 1B′ can be more effectively prevented, and the dimensional accuracy of the three-dimensional shaped article 10 can be further improved.

A curing treatment in which the curing reaction of the curable resin is allowed to proceed can be performed by, for example, heating or irradiation with an energy ray such as a UV ray.

As the curable resin, for example, various thermosetting resins, photocurable resins, and the like can be favorably used.

As the curable resin (polymerizable compound), for example, various monomers, various oligomers (including dimers, trimers, etc.), prepolymers, and the like can be used.

As the curable resin (polymerizable compound), a compound whose addition polymerization or ring-opening polymerization is initiated by a radical species, a cationic species, or the like generated from a polymerization initiator by irradiation with an energy ray, thereby forming a polymer is preferably used. As the polymerization form of the addition polymerization, radical, cationic, anionic, metathesis, and coordination polymerization are exemplified. Further, as the polymerization form of the ring-opening polymerization, cationic, anionic, radical, metathesis, and coordination polymerization are exemplified.

In the entity portion forming composition 1B′, the other binder may be contained in any form, however, it is preferably in the form of a liquid (for example, in a molten state, a dissolved state, or the like). That is, it is preferably contained as a constituent component of a dispersion medium.

According to this, the other binder can function as a dispersion medium for dispersing the particles, and the preservability of the entity portion forming composition 1B′ can be further improved.

As specific examples of the other binder, for example, an acrylic resin, an epoxy resin, a silicone resin, polyvinyl alcohol, PLA (polylactic acid), PA (polyamide), PPS (polyphenylene sulfide), etc. are exemplified.

Particularly, by including polyvinyl alcohol, the smoothness of the surface of the layer 1 can be improved, and the dimensional accuracy of the three-dimensional shaped article 10 can be further improved.

The content ratio of the other binder in the entity portion forming composition 1B′ is preferably 2.0 mass % or less, more preferably 1.0 mass % or less, further more preferably 0.5 mass % or less.

According to this, the residual amount of carbon in the three-dimensional shaped article 10 to be finally obtained can be more reliably reduced, and the purity of the three-dimensional shaped article 10 can be more reliably improved. Further, the preservability, ejection property, and the like of the entity portion forming composition 1B′ can be further improved.

### Other Components

Further, the entity portion forming composition 1B′ may contain a component other than the above-mentioned components. As such a component, for example, a polymerization initiator, a dispersant, a surfactant, a thickener, an anti-aggregation agent, a defoaming agent, a slipping agent (leveling agent), a dye, a polymerization inhibitor, a polymerization accelerator, a permeation accelerator, a wetting agent (humectant), a fixing agent, an antifungal agent, a preservative, an antioxidant, a UV absorber, a chelating agent, a pH adjusting agent, etc. are exemplified.

### Support Portion Forming Composition

Next, the support portion forming composition TA′ as the three-dimensional shaped article producing composition used for producing the three-dimensional shaped article 10 will be described.

The constituent component or the like of the support portion forming composition 1A′ is not particularly limited as long as the composition can be used for forming the support portion 5 (forming the first pattern 1A), however, the composition preferably contains a plurality of particles (main material particles) and a solvent for dispersing the particles, and more preferably further contains nanocellulose.

In the following description, a case where the support portion forming composition 1A′ contains a plurality of particles, a solvent, and nanocellulose will be representatively described.

### Particles

By including a plurality of particles in the support portion forming composition 1A′, even when the support portion 5 (first pattern 1A) to be formed has a fine shape or the like, the support portion 5 can be efficiently formed with high dimensional accuracy. Further, the solvent or the binder (including a decomposition product) can be efficiently removed from voids among the plurality of particles constituting the support portion 5, and the productivity of the three-dimensional shaped article 10 can be further improved. In addition, the solvent, the binder, or the like can be more effectively prevented from undesirably remaining in the binder removed body 70, and the reliability of the three-dimensional shaped article 10 to be finally obtained can be further improved.

As the constituent material of the particles contained in the support portion forming composition 1A′, for example, the same materials as described as the constituent material of the entity portion forming composition 1B′ are exemplified. According to this, the same effect as described above is obtained.

However, the particles constituting the support portion forming composition 1A′ are preferably constituted by a material having a higher melting point than the particles constituting the entity portion forming composition 1B′.

The shape of the particle is not particularly limited, and may be any shape such as a spherical shape, a spindle shape, a needle shape, a cylindrical shape, or a flaky shape, and further, it may be an irregular shape, but is preferably a spherical shape.

The average particle diameter of the particles is not particularly limited, but is preferably 0.1 μm or more and 20 μm or less, more preferably 0.2 μm or more and 10 μm or less.

According to this, the fluidity of the support portion forming composition 1A′ becomes more favorable, and therefore, the first pattern forming step can be more smoothly performed. Further, the solvent or the binder (including a decomposition product) can be more efficiently removed from voids among the plurality of particles constituting the support portion 5 (first pattern LA), and the productivity of the three-dimensional shaped article 10 can be further improved. In addition, the solvent, the binder, or the like can be more effectively prevented from undesirably remaining in the binder removed body 70, and the reliability of the three-dimensional shaped article 10 to be finally obtained can be further improved. In addition, the dimensional accuracy of the three-dimensional shaped article 10 can be further improved.

The Dmax of the particles is preferably 0.2 μm or more and 25 μm or less, more preferably 0.4 μm or more and 15 μm or less.

According to this, the fluidity of the support portion forming composition 1A′ becomes more favorable, and therefore, supply of the support portion forming composition 1A′ can be more smoothly performed. Further, the solvent or the binder (including a decomposition product) can be more efficiently removed from voids among the plurality of particles constituting the support portion 5 (first pattern LA), and the productivity of the three-dimensional shaped article 10 can be further improved. In addition, the solvent, the binder, or the like can be more effectively prevented from undesirably remaining in the binder removed body 70, and the reliability of the three-dimensional shaped article 10 to be finally obtained can be further improved. In addition, the dimensional accuracy of the three-dimensional shaped article 10 can be further improved.

The content ratio of the particles in the support portion forming composition 1A′ is preferably 30 mass % or more and 93 mass % or less, more preferably 35 mass % or more and 88 mass % or less.

According to this, while further improving the ease of handling of the support portion forming composition 1A′, the amount of components to be removed in the production process for the three-dimensional shaped article 10 can be further reduced, and therefore, it is particularly advantageous in terms of the productivity of the three-dimensional shaped article 10, the production cost thereof, saving resources, and the like. In addition, the dimensional accuracy of the three-dimensional shaped article 10 to be finally obtained can be further improved.

Incidentally, the particles may be constituted by a material to undergo a chemical reaction (for example, an oxidation reaction or the like) in the production process for the three-dimensional shaped article 10.

Further, the support portion forming composition 1A′ may contain two or more types of particles.

### Solvent

By including the solvent in the support portion forming composition 1A′, the particles can be favorably dispersed in the support portion forming composition 1A′, and the ejection of the support portion forming composition 1A′ by a dispenser or the like can be stably performed.

As the solvent contained in the support portion forming composition 1A′, for example, the same solvents as described as the constituent material of the entity portion forming composition 1B′ are exemplified. According to this, the same effect as described above is obtained.

Incidentally, the formulation of the solvent contained in the support portion forming composition 1A′ may be the same as or different from the formulation of the solvent contained in the entity portion forming composition 1B′.

The content of the solvent in the support portion forming composition 1A′ is preferably 5 mass % or more and 68 mass % or less, more preferably 8 mass % or more and 60 mass % or less.

According to this, while further improving the ease of handling of the support portion forming composition 1A′, the amount of components to be removed in the production process for the three-dimensional shaped article 10 can be further reduced, and therefore, it is particularly advantageous in terms of the productivity of the three-dimensional shaped article 10, the production cost thereof, saving resources, and the like. In addition, the dimensional accuracy of the three-dimensional shaped article 10 to be finally obtained can be further improved.

### Nanocellulose

By including nanocellulose in the support portion forming composition 1A′, the same effect as described above is obtained.

When the support portion forming composition 1A′ contains nanocellulose, the nanocellulose preferably satisfies the same conditions as described in the section of the constituent component of the entity portion forming composition 1B′. According to this, the same effect as described above is obtained.

Incidentally, the nanocellulose contained in the support portion forming composition 1A′ may satisfy the same conditions (for example, formulation, content ratio, etc.) as those for the nanocellulose contained in the entity portion forming composition 1B′ or may satisfy different conditions.

### Other Binder

As described above, the nanocellulose also has a function as a binder for temporarily binding the particles to one another in a state where the solvent is removed (a function to temporarily bind the particles to one another in the layer 1 in a state where the solvent is removed), however, the support portion forming composition 1A′ may further contain a component functioning as a binder other than the nanocellulose (other binder).

According to this, a strength to temporarily bind the particles to one another in a state where the solvent is removed can be enhanced, and undesirable scattering or the like of the particles can be more effectively prevented.

As the other binder, for example, various resin materials such as a thermoplastic resin and a curable resin, and the like can be used.

When a curable resin is contained, a curing reaction of the curable resin may be performed at a timing after ejection of the support portion forming composition 1A′ and before the joining step.

According to this, undesirable deformation of the pattern formed using the support portion forming composition 1A′ can be more effectively prevented, and the dimensional accuracy of the three-dimensional shaped article 10 can be further improved.

A curing treatment in which the curing reaction of the curable resin is allowed to proceed can be performed by, for example, heating or irradiation with an energy ray such as a UV ray.

When the support portion forming composition 1A′ contains a curable resin, as the curable resin, for example, the same material as described as the constituent component of the entity portion forming composition 1B′ can be used.

Incidentally, the curable resin contained in the support portion forming composition 1A′ and the curable resin contained in the entity portion forming composition 1B′ may have the same conditions (for example, the same formulation, etc.) or may have different conditions.

In the support portion forming composition 1A′, the other binder may be contained in any form, however, it is preferably in the form of a liquid (for example, in a molten state, a dissolved state, or the like). That is, it is preferably contained as a constituent component of a dispersion medium.

According to this, the other binder can function as a dispersion medium for dispersing the particles, and the preservability of the support portion forming composition 1A′ can be further improved.

As specific examples of the other binder, for example, an acrylic resin, an epoxy resin, a silicone resin, polyvinyl alcohol, PLA (polylactic acid), PA (polyamide), PPS (polyphenylene sulfide), etc. are exemplified.

Particularly, by including polyvinyl alcohol, the smoothness of the surface of the layer 1 can be improved, and the dimensional accuracy of the three-dimensional shaped article 10 can be further improved.

The content ratio of the other binder in the support portion forming composition 1A′ is preferably 2.0 mass % or less, more preferably 1.0 mass % or less, further more preferably 0.5 mass % or less.

According to this, the preservability, ejection property, and the like of the support portion forming composition 1A′ can be further improved.

### Other Components

Further, the support portion forming composition 1A′ may contain a component other than the above-mentioned components. As such a component, for example, a polymerization initiator, a dispersant, a surfactant, a thickener, an anti-aggregation agent, a defoaming agent, a slipping agent (leveling agent), a dye, a polymerization inhibitor, a polymerization accelerator, a permeation accelerator, a wetting agent (humectant), a fixing agent, an antifungal agent, a preservative, an antioxidant, a UV absorber, a chelating agent, a pH adjusting agent, etc. are exemplified.

### Three-Dimensional Shaped Article Producing Composition Set

Next, a three-dimensional shaped article producing composition set according to the invention will be described.

The three-dimensional shaped article producing composition set according to the invention includes a plurality of types of compositions used for producing a three-dimensional shaped article, and includes the three-dimensional shaped article producing composition of the invention as described above (a composition containing a plurality of particles, a solvent, and nanocellulose) as at least one type of the compositions.

According to this, the three-dimensional shaped article producing composition set that can be used for producing a three-dimensional shaped article having excellent dimensional accuracy and reliability with high productivity can be provided.

The three-dimensional shaped article producing composition set may include at least one type of three-dimensional shaped article producing composition of the invention as described above, but preferably includes two or more types of three-dimensional shaped article producing compositions of the invention.

According to this, the dimensional accuracy and reliability of the three-dimensional shaped article can be further improved.

Further, it is preferred that the three-dimensional shaped article producing composition set includes at least one type of entity portion forming composition 1B′ used for forming the entity portion 2 of the three-dimensional shaped article 10 and also includes at least one type of support portion forming composition 1A′ used for forming the support portion 5.

According to this, the dimensional accuracy and reliability of the three-dimensional shaped article 10 can be further improved.

### Three-Dimensional Shaped Article Production Apparatus

Next, a three-dimensional shaped article production apparatus of the invention will be described.

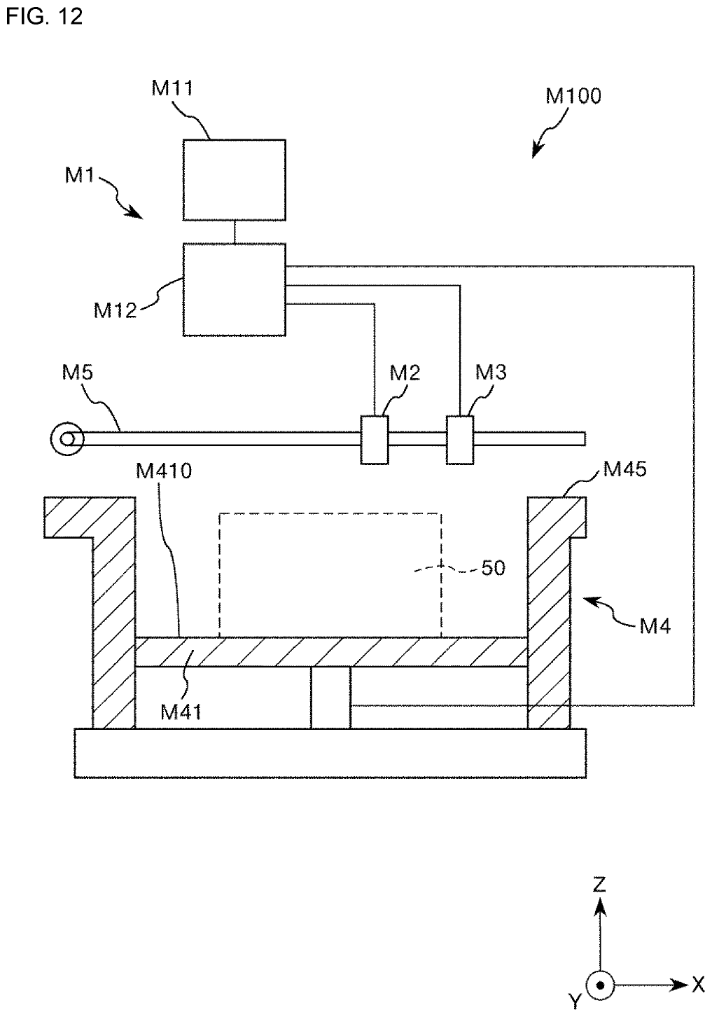

FIG. 12 is a side view schematically showing a preferred embodiment of the three-dimensional shaped article production apparatus.

A three-dimensional shaped article production apparatus M100 includes a nozzle ejecting the three-dimensional shaped article producing composition of the invention, and forms a layer 1 by ejecting the three-dimensional shaped article producing composition from the nozzle and produces a three-dimensional shaped article 10 by stacking the layer 1.

More specifically, the three-dimensional shaped article production apparatus M100 is an apparatus used for producing the three-dimensional shaped article 10 by repeatedly performing the formation of the layer 1, and includes a control unit (controlling unit) M1, a support portion forming composition ejection nozzle (first nozzle) M2 ejecting a support portion forming composition 1A′ (three-dimensional shaped article producing composition 1′) used for forming a support portion 5 supporting a portion to become an entity portion 2 of the three-dimensional shaped article 10, and an entity portion forming composition ejection nozzle (second nozzle) M3 ejecting an entity portion forming composition 1B′ (three-dimensional shaped article producing composition 1′) used for forming the entity portion 2 of the three-dimensional shaped article 10. Then, at least one of the support portion forming composition 1A′ and the entity portion forming composition 1B′ (preferably at least the entity portion forming composition 1B′, more preferably both of the support portion forming composition 1A′ and the entity portion forming composition 1B′) is the three-dimensional shaped article producing composition of the invention (a composition containing a plurality of particles, a solvent, and nanocellulose).

According to this, the production method of the invention as described above can be favorably performed, and the three-dimensional shaped article 10 having excellent dimensional accuracy and reliability can be produced with high productivity.

The control unit M1 includes a computer M11 and a drive control unit M12.

The computer M11 is a general desktop computer or the like configured to include a CPU, a memory, etc. therein. The computer M11 generates data as model data from the shape of the three-dimensional shaped article 10 and outputs sectional data (slice data) obtained by slicing the data into several parallel layers of thin sectional bodies to the drive control unit M12.

The drive control unit M12 included in the control unit M1 functions as a controlling unit that drives each of the support portion forming composition ejection nozzle M2, the entity portion forming composition ejection nozzle M3, a layer forming portion M4, and the like. Specifically, the drive control unit M12 controls, for example, driving (moving on an X-Y plane or the like) of the support portion forming composition ejection nozzle M2 and the entity portion forming composition ejection nozzle M3, ejection of the support portion forming composition 1A′ by the support portion forming composition ejection nozzle M2, ejection of the entity portion forming composition 1B′ by the entity portion forming composition ejection nozzle M3, lowering of a stage (lifting stage) M41 movable in the Z direction in FIG. 12 and an amount of lowering of the stage, and the like.

To each of the support portion forming composition ejection nozzle M2 and the entity portion forming composition ejection nozzle M3, a pipe from a material storage portion (material supply portion) (not shown) is coupled. In this material supply portion, the above-mentioned three-dimensional shaped article producing composition 1′ is stored and ejected from the support portion forming composition ejection nozzle M2 and the entity portion forming composition ejection nozzle M3 by the control of the drive control unit M12.

The support portion forming composition ejection nozzle M2 and the entity portion forming composition ejection nozzle M3 can move along a guide M5 independently in each of the X direction and the Y direction in FIG. 12.

The layer forming portion M4 includes the stage (lifting stage) M41 that is supplied with the support portion forming composition 1A′ and the entity portion forming composition 1B′ and that supports the layer 1 formed using the support portion forming composition 1A′ and the entity portion forming composition 1B′, and a frame M45 surrounding the lifting stage M41.

The lifting stage M41 sequentially descends (moves toward the negative direction of the Z axis) by a predetermined amount according to a command from the drive control unit M12 when a new layer 1 is formed (stacked) on the previously formed layer 1.

An upper surface (in more detail, a portion to which the support portion forming composition 1A′ and the entity portion forming composition 1B′ are applied) of the stage M41 becomes a flat plane (liquid receiving face) M410. According to this, the layer 1 with high thickness uniformity can be easily and reliably formed.

The stage M41 is preferably constituted by a high-strength material. As the constituent material of the stage M41, for example, various metal materials such as a stainless steel, etc. are exemplified.

Further, the plane M410 of the stage M41 may be subjected to a surface treatment. According to this, for example, the constituent material of the support portion forming composition 1A′ or the constituent material of the entity portion forming composition 1B′ is more effectively prevented from firmly adhering to the stage M41, or the durability of the stage M41 is improved, and thus, stable production of the three-dimensional shaped article 10 over a long period of time can be achieved. As the material used in the surface treatment of the plane M410 of the stage M41, for example, a fluorine-based resin such as polytetrafluoroethylene, etc. are exemplified.

The support portion forming composition ejection nozzle M2 is configured to move according to the command from the drive control unit M12 and eject the support portion forming composition 1A′ at a desired site on the stage M41 in a predetermined pattern.

As the support portion forming composition ejection nozzle M2, for example, an inkjet head nozzle, various dispenser nozzles, etc. are exemplified, but it is preferably a dispenser nozzle.

According to this, even the support portion forming composition 1A′ having a high viscosity can be favorably supplied (ejected), and dripping or the like of the support portion forming composition 1A′ after the support portion forming composition 1A′ comes in contact with a target site can be more effectively prevented. As a result, the dimensional accuracy of the three-dimensional shaped article 10 to be finally obtained can be further improved. In addition, by using the support portion forming composition 1A′ having a high viscosity, the layer 1 having a relatively large thickness can be easily formed, and the productivity of the three-dimensional shaped article 10 can be further improved.

The size (nozzle diameter) of the ejection portion of the support portion forming composition ejection nozzle M2 is not particularly limited, but is preferably 10 μm or more and 100 μm or less.

According to this, the productivity of the three-dimensional shaped article 10 can be further improved while further improving the dimensional accuracy of the three-dimensional shaped article 10.

The support portion forming composition ejection nozzle M2 preferably ejects the support portion forming composition 1A′ as a liquid droplet. According to this, the support portion forming composition 1A′ can be applied in a fine pattern, and even the three-dimensional shaped article 10 having a fine structure can be produced with particularly high dimensional accuracy and particularly high productivity.

The entity portion forming composition ejection nozzle M3 is configured to move according to the command from the drive control unit M12 and eject the entity portion forming composition 1B′ at a desired site on the stage M41 in a predetermined pattern.

As the entity portion forming composition ejection nozzle M3, for example, an inkjet head nozzle, various dispenser nozzles, etc. are exemplified, but it is preferably a dispenser nozzle.

According to this, even the entity portion forming composition 1B′ having a high viscosity can be favorably supplied (ejected), and dripping or the like of the entity portion forming composition 1B′ after the entity portion forming composition 1B′ comes in contact with a target site can be more effectively prevented. As a result, the dimensional accuracy of the three-dimensional shaped article 10 to be finally obtained can be further improved. In addition, by using the entity portion forming composition 1B′ having a high viscosity, the layer 1 having a relatively large thickness can be easily formed, and the productivity of the three-dimensional shaped article 10 can be further improved.

The size (nozzle diameter) of the ejection portion of the entity portion forming composition ejection nozzle M3 is not particularly limited, but is preferably 10 μm or more and 100 μm or less.

According to this, the productivity of the three-dimensional shaped article 10 can be further improved while further improving the dimensional accuracy of the three-dimensional shaped article 10.

The entity portion forming composition ejection nozzle M3 preferably ejects the entity portion forming composition 1B′ as a liquid droplet. According to this, the entity portion forming composition 1B′ can be applied in a fine pattern, and even the three-dimensional shaped article 10 having a fine structure can be produced with particularly high dimensional accuracy and particularly high productivity.

According to the configuration as described above, a stacked body 50 can be obtained by stacking a plurality of layers 1.

By performing the binder removing treatment and the joining treatment (sintering treatment) for the obtained stacked body 50, the three-dimensional shaped article 10 can be obtained.

The three-dimensional shaped article production apparatus M100 of this embodiment may include a binder removing unit (not shown) that performs the binder removing treatment, and a joining unit (sintering unit) (not shown) that performs the joining treatment (sintering treatment).

According to this, the formation or the like of the layer 1, the binder removing treatment, and the joining treatment can be performed by the same apparatus, and the productivity of the three-dimensional shaped article 10 can be further improved.

### Three-Dimensional Shaped Article

The three-dimensional shaped article according to the invention can be produced using the three-dimensional shaped article production apparatus of the invention as described above.

According to this, the three-dimensional shaped article having excellent dimensional accuracy and reliability can be produced with high productivity.

The use of the three-dimensional shaped article is not particularly limited, however, for example, an appreciation article and an exhibit such as a doll and a figure; a medical device such as an implant; etc. are exemplified.

In addition, the three-dimensional shaped article may be applied to any of a prototype, a mass-produced product, and a custom-made product.

Hereinabove, preferred embodiments of the invention are described, however, the invention is not limited thereto.

For example, in the above-mentioned embodiments, the description has been made under the assumption that with respect to a single layer, the second pattern forming step is performed after the first pattern forming step, however, in the formation of at least one layer, the order of the first pattern forming step and the second pattern forming step may be reversed. Further, a plurality of types of compositions may be simultaneously applied in different regions.

Further, in the above-mentioned embodiments, a case where with respect to a single layer, the solvent removing step is performed after performing the first pattern forming step and the second pattern forming step is representatively described, however, for example, the solvent removing step may be individually performed each time after the first pattern forming step and after the second pattern forming step.

Further, in the above-mentioned embodiments, a case where in the formation of all layers, the first pattern and the second pattern are formed is representatively described, however, the stacked body may include, for example, a layer that does not have the first pattern or a layer that does not have the second pattern. Further, a layer in which a portion corresponding to the entity portion is not formed (for example, a layer constituted by only the support portion) is formed in a contact face with the stage (right above the stage) and the layer may be made to function as a sacrificial layer.

Further, in the production method for a three-dimensional shaped article of the invention, the order of the steps or treatments is not limited to the order described above, and the steps or treatments may be performed by changing the order of at least some of them. For example, in the above-mentioned embodiments, a case where the binder removing step, the joining step, and the support portion removing step are performed in this order after the stacked body is obtained is representatively described, however, the order of these may be changed. More specifically, the steps may be performed in the order of the binder removing step, the support portion removing step, and the joining step, or in the order of the support portion removing step, the binder removing step, and the joining step. Further, for example, the layer forming step and the solvent removing step may be concurrently performed. In addition, the joining treatment may be performed for the respective layers one after another. In that case, the joining treatment for the respective layers can be favorably performed by, for example, irradiation with a laser beam.

Further, in the joining step, the removal of the binder may be performed together with the joining of the particles, and in such a case, the binder removing step can be omitted.

Further, in the above-mentioned embodiments, a case where in the joining step, the joining of the particles contained in the entity portion forming composition is performed and also the joining of the particles contained in the support portion forming composition is performed is mainly described, however, in the joining step, the joining of the particles contained in the entity portion forming composition is selectively performed, and the particles contained in the support portion forming composition may not be joined to one another. Such selective joining can be favorably performed by adjusting the relationship between the melting point of the constituent material of each particle and the temperature in the sintering step.

Further, the support portion may not be formed depending on the shape of the three-dimensional shaped article to be produced.

Further, in the above-mentioned embodiments, a case where a layer having a desired shape is formed by ejecting the three-dimensional shaped article producing composition in a predetermined pattern is representatively described, however, the invention may be applied to a method in which a layer is formed by flattening the three-dimensional shaped article producing composition using a flattening unit such as a squeezee or a roller, and a joined portion is formed by irradiating the layer with a laser beam, or the like (an SLS method or the like).

Further, in the production method of the invention, a pre-treatment step, an intermediate-treatment step, or a post-treatment step may be performed as needed.

As the pre-treatment step, for example, a stage cleaning step, etc. are exemplified.

As the post-treatment step, for example, a washing step, a shape adjusting step in which deburring or the like is performed, a coloring step, a coating layer forming step, a heat treatment step for improving the joining strength between particles, etc. are exemplified.

Further, in the three-dimensional shaped article production apparatus of the invention, the configuration of each portion can be replaced with an arbitrary configuration exhibiting a similar function, and further, an arbitrary configuration can also be added.

In addition, in the above-mentioned embodiments, a case where a layer is directly formed in the surface of the stage is representatively described, however, for example, a shaping plate is placed on the stage, and a three-dimensional shaped article may be produced by staking layers on the shaping plate.

Further, the production method for a three-dimensional shaped article of the invention is not limited to the method performed by using the three-dimensional shaped article production apparatus as described above.

### EXAMPLES

Hereinafter, the invention will be described in more detail with reference to specific examples, however, the invention is not limited only to these examples. Incidentally, in the following description, a treatment for which a temperature condition is not particularly shown was performed at room temperature (25° C.). Further, also with respect to various measurement conditions, when a temperature condition is not particularly shown, a value is obtained at room temperature (25° C.)

### Example 1

### 1. Production of Three-Dimensional Shaped Article Producing Composition

An SUS 316L powder having an average particle diameter of 3.0 μm: 100 parts by mass, glycerin as a solvent: 28.33 parts by mass, and nanocellulose constituted by cellulose: 0.071 parts by mass were mixed, whereby an entity portion forming composition as a three-dimensional shaped article producing composition (layer forming composition) was obtained. In the thus obtained entity portion forming composition, the nanocellulose covered the surfaces of the constituent particles of the SUS 316L powder. The surface state was observed by rapidly freezing the entity portion forming composition at a liquid nitrogen temperature and processing it as it is in an SEM apparatus equipped with an FIB.

Further, an alumina powder having an average particle diameter of 3.0 μm: 100 parts by mass, glycerin as a solvent: 28.33 parts by mass, and nanocellulose constituted by cellulose: 0.071 parts by mass were mixed, whereby a support portion forming composition as a three-dimensional shaped article producing composition (layer forming composition) was obtained. In the thus obtained support portion forming composition, the nanocellulose covered the surfaces of the constituent particles of the alumina powder.

By doing this, a three-dimensional shaped article producing composition set composed of the entity portion forming composition and the support portion forming composition was obtained.

### 2. Production of Three-Dimensional Shaped Article

By using the three-dimensional shaped article producing compositions obtained as described above, a three-dimensional shaped article in a rectangular parallelepiped shape having a designed dimension of 4 mm in thickness, 10 mm in width, and 80 mm in length was produced as follows.

First, a three-dimensional shaped article production apparatus as shown in FIG. 12 was prepared, and the support portion forming composition was ejected as a plurality of liquid droplets in a predetermined pattern on a stage from a support portion forming composition ejection nozzle of a dispenser, whereby a first pattern (support portion pattern) was formed.

Subsequently, the entity portion forming composition was ejected as a plurality of liquid droplets in a predetermined pattern on the stage from an entity portion forming composition ejection nozzle of a dispenser, whereby a second pattern (entity portion pattern) was formed.

By doing this, a layer composed of the first pattern and the second pattern was formed. The thickness of the layer was 50 μm.

Thereafter, the layer composed of the first pattern and the second pattern was subjected to a heating treatment at 200° C., whereby the solvent contained in the layer was removed (solvent removing step).

Thereafter, by repeatedly performing a new layer forming step (the first pattern forming step and the second pattern forming step) on the layer from which the solvent was removed, and the solvent removing step, a stacked body having a shape corresponding to the three-dimensional shaped article to be produced was obtained.

Subsequently, the obtained stacked body was subjected to a binder removing treatment by heating in nitrogen gas under conditions of 400° C.×5 hours, whereby a binder removed body was obtained.

Subsequently, from the binder removed body, the support portion was removed by a method of brushing off the support portion with a brush.

Thereafter, the binder removed body from which the support portion was removed was subjected to a sintering treatment (joining treatment) by heating in hydrogen gas under conditions of 1,320° C.×2 hours, whereby a three-dimensional shaped article was obtained.

### Examples 2 to 9

Three-dimensional shaped article producing compositions (three-dimensional shaped article producing composition sets) and three-dimensional shaped articles were produced in the same manner as in the above-mentioned Example 1 except that the formulations of the entity portion forming composition and the support portion forming composition were set as shown in Tables 1 and 2.

### Comparative Example 1

Three-dimensional shaped article producing compositions (a three-dimensional shaped article producing composition set) and a three-dimensional shaped article were produced in the same manner as in the above-mentioned Example 1 except that the nanocellulose was not used as a constituent component of the entity portion forming composition and the support portion forming composition.

### Comparative Examples 2 and 3

Three-dimensional shaped article producing compositions (three-dimensional shaped article producing composition sets) and three-dimensional shaped articles were produced in the same manner as in the above-mentioned Example 1 except that polyvinyl alcohol was used in place of the nanocellulose as a constituent component of the entity portion forming composition and the support portion forming composition, and the used amounts of the respective components were set as shown in Tables 1 and 2.

The formulations of the three-dimensional shaped article producing compositions (three-dimensional shaped article producing composition sets) of the above-mentioned respective Examples and Comparative Examples are summarized and shown in Tables 1 and 2. Incidentally, in the tables, polyvinyl alcohol is denoted by “PVA”

Further, the values of the viscosity of the support portion forming compositions and the entity portion forming compositions used in the above-mentioned respective Examples and Comparative Example 3 were all within a range of 1,000 mPa·s or more and 20,000 mPa·s or less. Further, the values of the volume per liquid droplet of the support portion forming compositions and the entity portion forming compositions in the above-mentioned respective Examples and Comparative Examples were all within a range of 50 pL or more and 100 pL or less. Further, in the above-mentioned respective Examples and Comparative Examples, the values of the content ratio of the solvent in the layer after the solvent removing step were all within a range of 0.5 mass % or more and 20 mass % or less. Further, in the support portion forming compositions and the entity portion forming compositions used in the above-mentioned respective Examples, the values of the width and the thickness of the nanocellulose were all within a range of 10 nm or more and 50 nm or less, and the values of the length of the nanocellulose were all within a range of 150 nm or more and 400 nm or less, and the values of the aspect ratio of the fiber of the nanocellulose were all within a range of 7 or more and 30 or less. Further, in all the support portion forming compositions and the entity portion forming compositions used in the above-mentioned respective Examples, the nanocellulose covered the surfaces of the particles, and the values of the coverage of the surfaces of the particles with the nanocellulose were all within a range of 80% or more and 100% or less.

TABLE 1

| | Entity portion forming composition | | | | | | | | | | |
|---|---|---|---|---|---|---|---|---|---|---|---|
| | Particles | | | Solvent | | | Nanocellulose | | Other binder | | |
| | Con- | Content | Content | Con- | Content | Content | Content | Content | | Content | Content |
| | stituent | [parts by | ratio | stituent | [parts by | ratio | [parts by | ratio | Constituent | [parts by | ratio |
| | material | mass] | [vol %] | material | mass] | [vol %] | mass] | [vol %] | material | mass] | [vol %] |
| Example 1 | SUS316L | 100 | 35.74 | Glycerin | 28.33 | 64.13 | 0.071 | 0.13 | — | — | — |
| Example 2 | SUS316L | 100 | 35.65 | Glycerin | 28.33 | 63.97 | 0.20 | 0.38 | — | — | — |
| Example 3 | SUS316L | 100 | 35.76 | Glycerin | 28.33 | 64.16 | 0.04 | 0.08 | — | — | — |
| Example 4 | SUS316L | 100 | 38.67 | Glycerin | 25.00 | 61.23 | 0.05 | 0.10 | — | — | — |
| Example 5 | SUS316L | 100 | 35.74 | Glycerin | 28.33 | 64.13 | 0.071 | 0.13 | — | — | — |
| Example 6 | SUS316L | 100 | 35.78 | Glycerin | 28.33 | 64.19 | 0.015 | 0.03 | — | — | — |
| Example 7 | SUS316L | 100 | 38.54 | Glycerin | 25.00 | 61.01 | 0.22 | 0.42 | — | — | — |
| Example 8 | SUS316L | 100 | 35.78 | Glycerin | 28.33 | 64.21 | 0.005 | 0.01 | — | — | — |
| Example 9 | SUS316L | 100 | 37.61 | Glycerin | 26.00 | 61.93 | 0.23 | 0.44 | — | — | — |
| Comparative | SUS316L | 100 | 35.7% | Glycerin | 28.33 | 64.21 | — | — | — | — | — |
| Example 1 | | | | | | | | | | | |
| Comparative | SUS316L | 100 | 35.73 | Glycerin | 28.33 | 64.10 | — | — | PVA | 0.071 | 0.17 |
| Example 2 | | | | | | | | | | | |
| Comparative | SUS316L | 100 | 30.99 | Glycerin | 28.33 | 55.61 | — | — | PVA | 6.5 | 13.4 |
| Example 3 | | | | | | | | | | | |

TABLE 2

| | Support portion forming composition | | | | | | | | | | |
|---|---|---|---|---|---|---|---|---|---|---|---|
| | Particles | | | Solvent | | | Nanocellulose | | Other binder | | |
| | Con- | Content | Content | Con- | Content | Content | Content | Content | | Content | Content |
| | stituent | [parts by | ratio | stituent | [parts by | ratio | [parts by | ratio | Constituent | [parts by | ratio |
| | material | mass] | [vol %] | material | mass] | [vol %] | mass] | [vol %] | material | mass] | [vol %] |
| Example 1 | Alumina | 100 | 53.23 | Glycerin | 28.33 | 46.67 | 0.071 | 0.13 | — | — | — |
| Example 2 | Alumina | 100 | 53.13 | Glycerin | 28.33 | 46.59 | 0.20 | 0.38 | — | — | — |
| Example 3 | Alumina | 100 | 53.25 | Glycerin | 28.33 | 46.69 | 0.04 | 0.08 | — | — | — |
| Example 4 | Alumina | 100 | 56.33 | Glycerin | 25.00 | 46.59 | 0.05 | 0.10 | — | — | — |
| Example 5 | Alumina | 100 | 53.23 | Glycerin | 28.33 | 46.67 | 0.071 | 0.13 | — | — | — |
| Example 6 | Alumina | 100 | 53.27 | Glycerin | 28.33 | 46.71 | 0.015 | 0.03 | — | — | — |
| Example 7 | Alumina | 100 | 56.19 | Glycerin | 25.00 | 43.48 | 0.22 | 0.42 | — | — | — |
| Example 8 | Alumina | 100 | 53.28 | Glycerin | 28.33 | 46.72 | 0.005 | 0.01 | — | — | — |
| Example 9 | Alumina | 100 | 55.23 | Glycerin | 26.00 | 44.44 | 0.23 | 0.44 | — | — | — |
| Comparative | Alumina | 100 | 53.28 | Glycerin | 28.33 | 46.72 | — | — | — | — | — |
| Example 1 | | | | | | | | | | | |
| Comparative | Alumina | 100 | 53.21 | Glycerin | 28.33 | 46.66 | — | — | PVA | 0.071 | 0.12 |
| Example 2 | | | | | | | | | | | |
| Comparative | Alumina | 100 | 47.89 | Glycerin | 28.33 | 41.99 | — | — | PVA | 6.5 | 10.12 |
| Example 3 | | | | | | | | | | | |

### 3. Evaluation

### 3.1 Productivity of Three-Dimensional Shaped Article Removal Efficiency of Binder

With respect to each of the above-mentioned respective Examples and Comparative Examples, by using each of the three-dimensional shaped article producing compositions (the entity portion forming composition and the support portion forming composition), stacked bodies were produced in the same manner as described above.

Thereafter, each of these stacked bodies was subjected to a heating treatment (binder removing treatment) at 400° C. in nitrogen gas.

A time until the amount of the binder contained in the stacked body reached 5% of the initial amount (a time until the content ratio of the solvent reached 1/20 of the content ratio thereof in the three-dimensional shaped article producing composition) was measured and evaluated according to the following criteria. It can be said that as the time is shorter, the productivity of the three-dimensional shaped article is higher.

A: The time until the amount of the binder reached 5% of the initial amount is less than 3 hours.

B: The time until the amount of the binder reached 5% of the initial amount is 3 hours of more and less than 4 hours.

C: The time until the amount of the binder reached 5% of the initial amount is 4 hours of more and less than 5 hours.

D: The time until the amount of the binder reached 5% of the initial amount is 5 hours of more and less than 6 hours.

E: The time until the amount of the binder reached 5% of the initial amount is 6 hours of more.

### 3.2 Dimensional Accuracy

With respect to each of the three-dimensional shaped articles of the above-mentioned respective Examples and Comparative Examples, the thickness, width, and length were measured, and the amounts of deviation from the design values were determined and evaluated according to the following criteria.

A: The largest amount of deviation from the design value among the amounts of deviation from the design values of the thickness, width, and length is less than 1.0%.

B: The largest amount of deviation from the design value among the amounts of deviation from the design values of the thickness, width, and length is 1.0% or more and less than 2.0%.

C: The largest amount of deviation from the design value among the amounts of deviation from the design values of the thickness, width, and length is 2.0% or more and less than 4.0%.

D: The largest amount of deviation from the design value among the amounts of deviation from the design values of the thickness, width, and length is 4.0% or more and less than 7.0%.

E: The largest amount of deviation from the design value among the amounts of deviation from the design values of the thickness, width, and length is 7.0% or more.

These results are summarized and shown in Table 3.

TABLE 3
Table 3

| | Productivity of three- | |
|---|---|---|
| | dimensional shaped article | Dimensional |
| | (removal efficiency of binder) | accuracy |
| Example 1 | A | A |
| Example 2 | A | A |
| Example 3 | A | A |
| Example 4 | A | A |
| Example 5 | A | A |
| Example 6 | A | A |
| Example 7 | A | A |
| Example 8 | A | C |
| Example 9 | C | A |
| Comparative Example 1 | A | E |
| Comparative Example 2 | A | D |
| Comparative Example 3 | E | D |

As apparent from Table 3, according to the invention, a three-dimensional shaped article having high dimensional accuracy and reliably could be efficiently produced. On the other hand, in Comparative Examples, satisfactory results could not be obtained. More specifically, in Comparative Example 1 in which the binder is not contained, the function to temporarily bind the particles to one another in a state where the solvent was removed was not exhibited, and the dimensional accuracy of the produced three-dimensional shaped article was remarkably low. Further, also in Comparative Example 2 in which the composition that does not contain nanocellulose and that contains other binder at a relatively low content ratio was used, the function to temporarily bind the particles to one another in a state where the solvent was removed was not sufficiently exhibited, and the dimensional accuracy of the produced three-dimensional shaped article was low. Further, in Comparative Example 3 in which the composition that does not contain nanocellulose and that contains other binder at a relatively high content ratio was used, the function to temporarily bind the particles to one another in a state where the solvent was removed was effectively exhibited, but the time required for removing the binder was long, and the productivity of the three-dimensional shaped article was low. In addition, in Comparative Example 3, the viscosity of the composition was high and the solid component content ratio was high, and therefore, the solid component adhered to the ejection nozzle of the dispenser, and it was difficult to perform stable ejection of liquid droplets for a long period of time.

The entire disclosure of Japanese Patent Application No. 2017-037571 filed on Feb. 28, 2017 is expressly incorporated by reference herein.

1-10. (canceled)

11. A three-dimensional shaped article producing composition for producing a three-dimensional shaped article, the composition comprising:
a plurality of particles;
a solvent for dispersing the particles; and
nanocellulose, wherein
the solvent contains at least one type selected from the group consisting of propylene glycol, dipropylene glycol, butanediol, and 1,3-butylene glycol.

12. The three-dimensional shaped article producing composition according to claim 11, wherein the nanocellulose covers the surfaces of the particles.

13. The three-dimensional shaped article producing composition according to claim 11, wherein a content ratio of the nanocellulose is 0.02 vol % or more and 0.42 vol % or less.

14. The three-dimensional shaped article producing composition according to claim 11, wherein the particles contain at least one of a metal material and a ceramic material.

15. A production method for a three-dimensional shaped article, comprising:
repeatedly performing a series of steps including:
a layer forming step of forming a layer using the three-dimensional shaped article producing composition including
a plurality of particles;
a solvent for dispersing the particles; and
nanocellulose, wherein
the solvent contains at least one type selected from the group consisting of propylene glycol, dipropylene glycol, butanediol, and 1,3-butylene glycol, and
a solvent removing step of removing the solvent contained in the layer.

16. The production method for a three-dimensional shaped article according to claim 15, wherein
the layer forming step includes a first pattern forming step of forming a first pattern and a second pattern forming step of forming a second pattern, and
the three-dimensional shaped article producing composition is used in at least one of the first pattern forming step and the second pattern forming step.

17. The production method for a three-dimensional shaped article according to claim 15, including a joining step of performing a joining treatment for joining the particles to one another after repeatedly performing the series of steps.

18. The production method for a three-dimensional shaped article according to claim 15, wherein the three-dimensional shaped article producing composition is ejected by a dispenser.
